(19) United States
(12) Patent Application Publication
(10) Pub. No.: US 2006/0180226 A1
(43) Pub. Date: Aug. 17, 2006

(54) Tap pipe extensions

(76) Inventor: Christopher Jonathan Waller, Southampton (GB)

Correspondence Address: BAKER & BOTTS, 30 ROCKEFELLER PLAZA, 44TH FLOOR, NEW YORK, NY, 10112, US

(21) Appl. No.: 10/508,298

(22) PCT Filed: Mar. 17, 2003
(86) PCT No.: PCT/GB03/01156

§ 371 Date: Jul. 5, 2005

(30) Foreign Application Priority Data
Mar. 20, 2002 (GB) 0206541.5
Jan. 14, 2003 (GB) 0300732.5

(51) Int. Cl. F16L 11/00

(52) U.S. Cl. 138/109; 285/8

(57) ABSTRACT

A tap pipe extension (11) comprises a first end (13) provided with first securing means to releasably secure the first end (13) to a tap inlet (5), a second end (14) provided with second securing means to releasably secure the second end to a fluid supply pipe (9), and a non-round formation (19) at a position remote from the first end (13), the pipe extension (11) being of a length greater than the length of the tap inlet (5). The arrangement is such that, in use, the non-round formation (19) is operable to secure the first securing means of the tap pipe extension (11) to the tap inlet (5). The tap pipe extension (11) may comprise a rigid tubular body (12) formed at opposite ends thereof with screw threads (17, 18). Alternatively the tap pipe extension (11) may comprise a rigid tubular body (12) to the lower end of which is secured a flexible hose (44), and the free end of the flexible hose (44) is provided with said second securing means.

The present invention relates to tap pipe extensions and is concerned in particular, although not exclusively, with tap pipe extensions which are used to interconnect a tap inlet pipe with a water supply.

A tap is typically mounted on an upper, horizontal surface at the rear of a sink unit. The sink basin extends downwardly in front of the horizontal surface and thus the area beneath the rear surface and behind the sink basin is only accessible from beneath the sink unit. A tap inlet extends from the tap through the surface and is connected to a water supply. Typically a plastic nut clamps the tap inlet to the sink and a second, metal nut connects the inlet to the water supply.

Similarly with a bath, the tap mounting region is not readily accessible from below.

The securing of both nuts and the application of PTFE tape to the tap inlet to provide a watertight seal is made difficult because of the restricted access to the tap inlet above and behind the sink basin or bath. It is also difficult to gain access to the nuts with a spanner or the like. Often other connections to a sink unit have to be removed to provide sufficient access to the tap inlet.

According to a first aspect of the present invention there is provided a tap pipe extension comprising a first end provided with first securing means to releasably secure the first end to a tap inlet, a second end provided with second securing means to releasably secure the second end to a fluid supply pipe, and a non-round formation at a position remote from the first end, the pipe extension being of a length greater than the length of the tap inlet, the arrangement being such that, in use, the non-round formation is operable to secure the first securing means of the tap pipe extension to the tap inlet.

Preferably the first securing means comprise screw threads to engage with screw threads on the tap inlet.

The second securing means preferably comprises screw threads to enable a connection to be made to the fluid supply pipe.

The tap pipe extension may comprise a rigid tubular body formed at opposite ends thereof with said screw threads of the first and second securing means.

Alternatively, the tap pipe extension may comprise a rigid tubular body to the lower end of which is secured a flexible hose, and the free end of the flexible hose is provided with said second securing means.

The provision of a flexible hose enables the tap pipe extension to be readily connected to a supply pipe even when the supply pipe is not aligned with the axis of the extension body and tap inlet. Also, this facilitates the connection with the supply pipe to be located in a more convenient position for the manipulation of tools.

Preferably the first securing means further comprises an annular clamping face which is substantially perpendicular to a longitudinal axis of the tap pipe extension such that, in use, part of a sink unit or bath is clamped between the tap and the clamping face, the non-round formation being operable to secure the first securing means to the tap inlet.

Preferably the non-round formation comprises at least one pair of opposed, parallel faces. More preferably the non-round formation comprises a hexagonal formation having three pairs of opposed, parallel faces.

Preferably the tap pipe extension, in use, connects a hot or cold water tap inlet of a hot or cold water tap to hot or cold water supply pipework.

Alternatively, in use, a first tap pipe extension connects a cold water inlet of a hot and cold water mixer tap to a cold water supply and a second tap pipe extension connects the hot water inlet and a hot water supply.

Preferably the first tap pipe extension and the second tap pipe extension are of different lengths.

Preferably only the securing means of the first tap pipe extension comprises a clamping face. More preferably the clamping face is defined by a peripheral annular shoulder.

Preferably a clamping plate is provided having at least two apertures through which, in use, respective tap pipe extensions are received. Preferably one of the apertures is substantially circular and the second aperture is substantially arcuate, the circular aperture receiving the tap pipe extension having the clamping face. Preferably the clamping plate is substantially circular.

Preferably, in use, the clamping plate is brought into clamping engagement with part of a sink unit by the clamping face on the first tap pipe extension.

According to a second aspect of the present invention there is provided a tap assembly comprising a tap having a tap inlet, a sink unit or bath, a tap pipe extension according to the first aspect of the invention, and fluid supply pipework, the first end of the tap pipe extension being secured to the tap inlet such that part of the sink unit or bath is clamped between the tap and the tap pipe extension, the second end of the tap pipe extension being secured to the fluid supply pipework.

Preferably the tap inlet or the first end of the tap pipe extension passes through an aperture in the sink unit or bath.

Other embodiments of the present invention may include any combination of the features or limitations referred to herein.

The present invention may be carried into practice in various ways. but embodiments will now be described by way of example only with reference to the accompanying drawings in which:

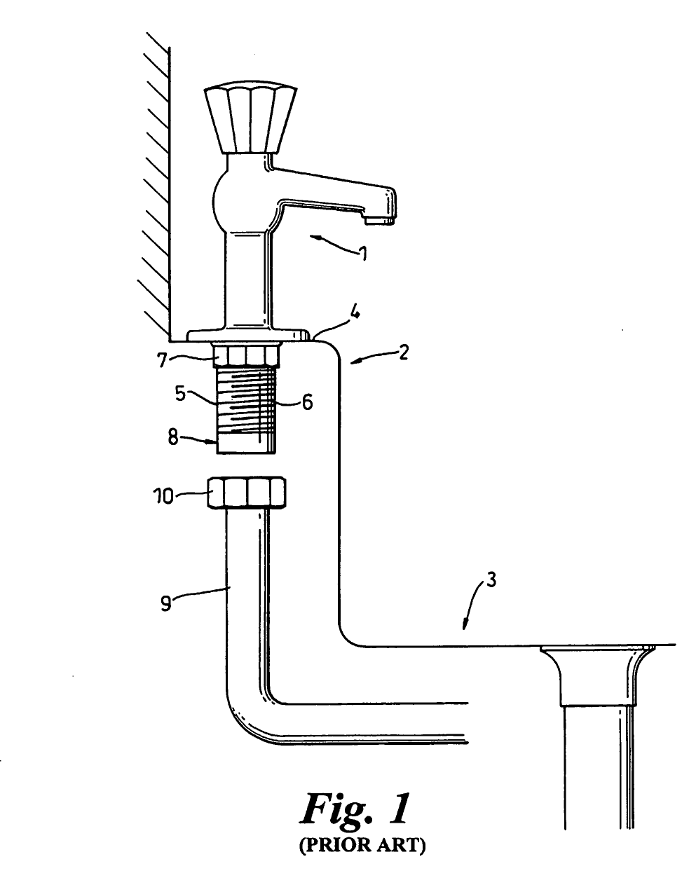

FIG. 1 is a part sectional side view of a prior art tap assembly with a water supply pipe not connected to the tap inlet;

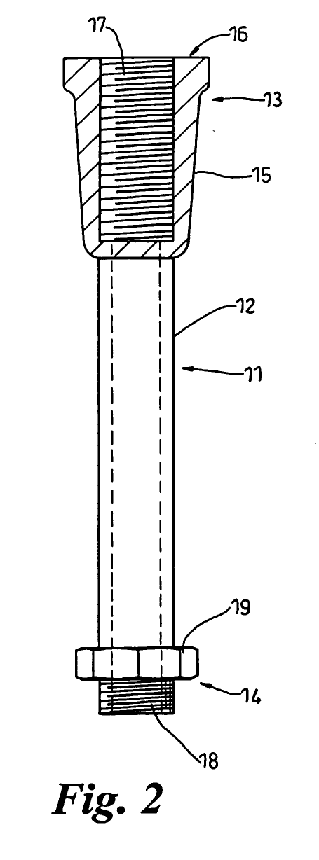

FIG. 2 is a part sectional side view of a tap pipe extension in accordance with the present invention;

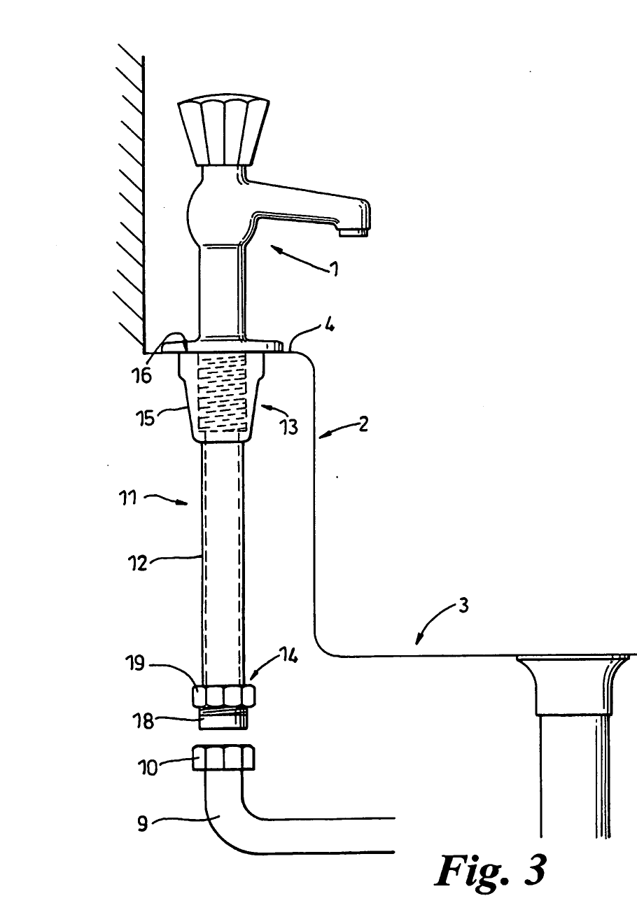

FIG. 3 is a part sectional side view of a tap assembly in accordance with the present invention with a water supply pipe not connected to the tap pipe extension;

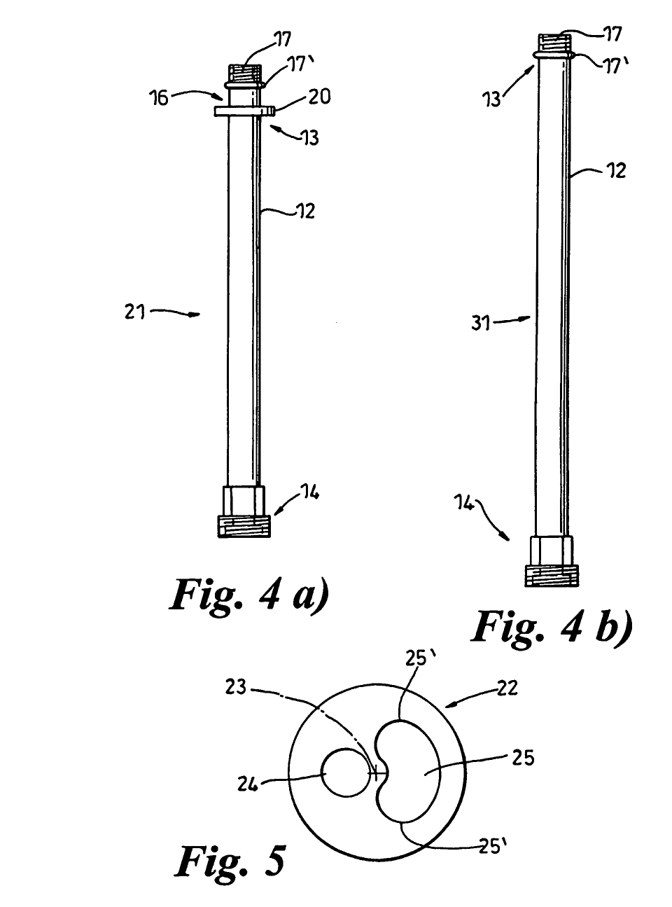

FIG. 4a) is a part sectional side view of a modified tap pipe extension and FIG. 4b) is a part sectional side view of a further modified tap pipe extension;

FIG. 5 is a plan view of a clamping plate in accordance with the present invention;

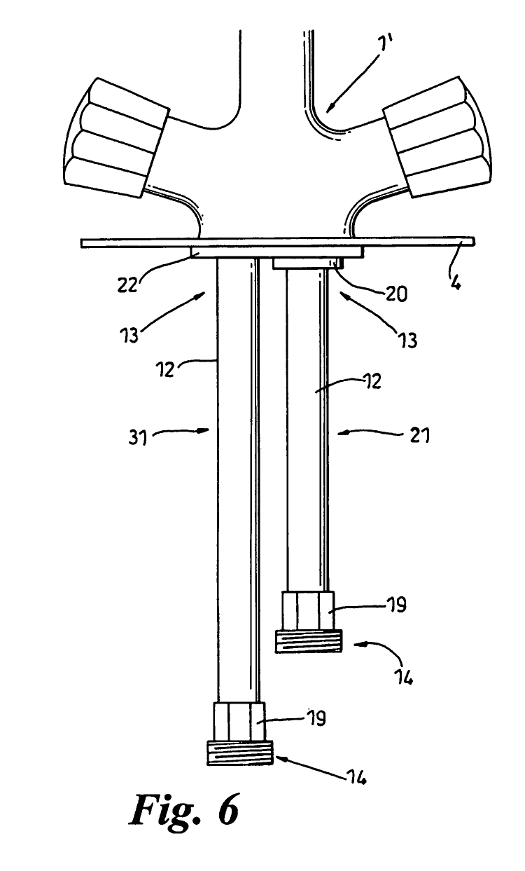

FIG. 6 is a front view of the tap pipe extensions of FIG. 4 and the clamping plate of FIG. 5 secured to a mixer tap;

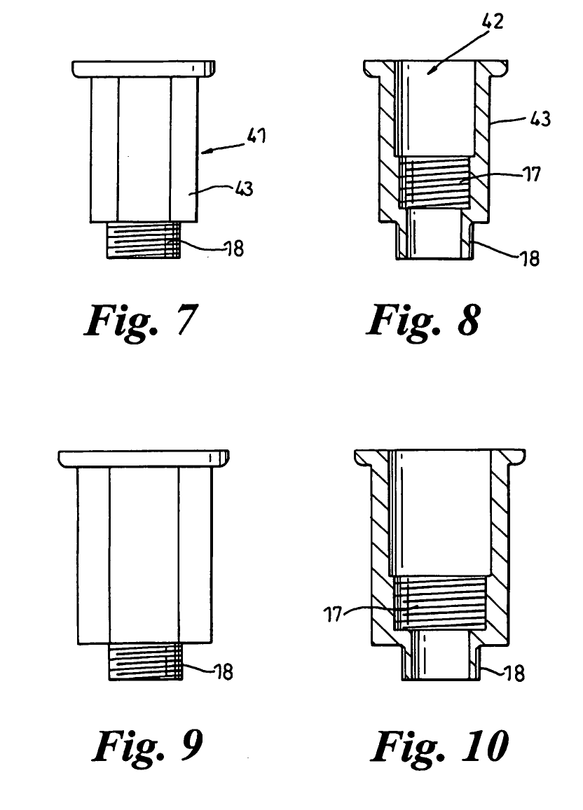

FIG. 7 is a side view of a further tap pipe extension in accordance with the invention and suitable for use with a wash basin tap;

FIG. 8 is a vertical cross-section of the extension of FIG. 7;

FIG. 9 is a side view of a further tap pipe extension similar to FIG. 7 but suitable for use with a bath tub tap;

FIG. 10 is a vertical cross-section of the extension of FIG. 9; and

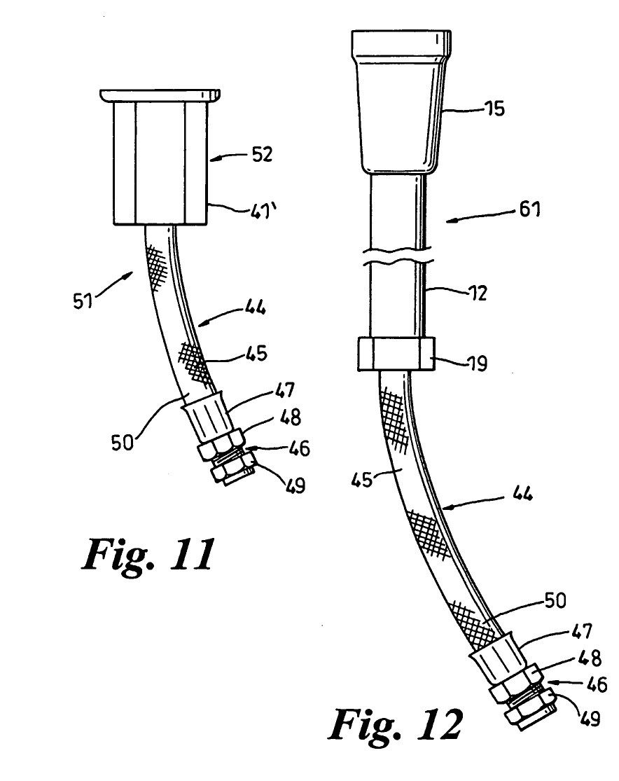

FIGS. 11 and 12 are side views of yet further tap pipe extensions in accordance with the invention, each comprising a flexible hose.

Referring initially to FIG. 1, a prior art tap assembly is shown comprising a tap 1 and a sink unit 2. The sink unit 2 comprises a sink basin 3 and a horizontal lip 4 extending from an upper edge of the rear of the sink basin 3. The lip 4 has an aperture (not shown) to receive part of the tap.

The tap 1 has a tap inlet pipe 5. The exterior of part of the tap inlet 5 is threaded 6. The tap inlet 5 extends through the aperture in the lip 4 when the tap 1 is placed on top of the lip 4 of the sink unit 2. A plastic nut 7 is threaded onto the tap inlet 5 and clamps the tap 1 to the lip 4 of the sink unit 2. This ensures the tap 1 stays in position during use and also ensures water does not leak under the tap 1 through the aperture. When the tap 1 is so clamped, PTFE tape 8 is applied to a lower end of the tap inlet 5. A connector pipe 9 is secured to the lower end of the tap inlet 5 by a second, metal nut 10. The engagement of the threads 6 on the tap inlet 5 and the second nut 10 with the PTFE tape 8 provides a watertight connection when the second nut 10 is tightened using a spanner or the like. The metal nut 10 can be a nut of the type sold under the trade name “Flow Flex”. The metal nut 10 ideally conforms to BS 864-2.

The tap inlet 5 is relatively short and extends only a small distance below the lip 4. The lower end of the tap inlet is a relatively large distance above the base of the sink basin 3. Thus access to both nuts 7 and 10 and the PTFE tape 8 is relatively restricted.

Referring now to FIG. 2, a tap pipe extension 11 in accordance with the present invention comprises an elongate pipe 12 having a first end 13 and a second, opposed end 14.

The first end 13 comprises an upwardly and outwardly flared region 15 terminating in an annular clamping face 16 which is substantially perpendicular to the longitudinal axis of the pipe 12. The clamping face 16 extends around the circumference of the first end 13 of the pipe 12. The first end 13 is internally threaded 17.

The second, opposed end 14 of the pipe 12 has an externally threaded portion 18 and a non-round formation 19 adjacent the threaded portion 18. The non-round formation 19 has a hexagonal transverse cross section. Any other transverse cross section having at least two parallel, opposed faces could, alternatively be used.

Both the flared region 15 and the non-round formation 19 are formed integrally with the pipe 12. Alternatively the flared region 15 and the non-round formation 19 are formed separately from the pipe 12 and subsequently secured to the pipe 12 using any suitable method such as, for example, adhesive.

In use, PTFE tape is applied by a plumber or the like to the lower end of the tap inlet 5 which is subsequently inserted through the aperture in the lip 4 of the sink unit 2. The plumber then holds the tap pipe extension 11 by the second end 14 and places the first end 13 adjacent the lower end of the tap inlet 5. The tap pipe extension 11 is then rotated by the second end 14 so that the threaded region 17 engages with the threaded region 6 on the tap inlet 5. The tap pipe extension 11 can be turned by pressure applied to the non-round formation 19 until the clamping face 16 engages with the under-side of the lip 4 to clamp the tap 1 to the lip 4. The tap pipe extension 11 is securely tightened using a spanner or other tightening tool which engages with the non-round formation 19. PTFE tape is then applied to the threaded portion 18 of the second end 14 which is then secured to the hot or cold water supply pipe 9 using the second nut 10. This creates a watertight connection.

The tap pipe extension 11 is significantly longer than the tap inlet 5 and extends to a position adjacent or beneath the base of the sink unit 2. The tap pipe extension 11 is turned and tightened by the non-round formation 19 which is also adjacent or beneath the base of the sink unit 2. Consequently the plumber does not have to reach up and behind the sink basin 3 to clamp the tap 1 to the lip 4 of the sink unit 2.

To tighten the tap pipe extension 11 to the tap inlet 5, a spanner is applied to the non-round formation 19 which is in an open space beneath or adjacent the base of the sink basin 3 and not in the confined space above and behind the sink basin 3 and beneath the lip 4. The entire operation, including connecting the tap pipe extension 11 to the water supply pipe 9, can be conducted with the second end 14 of the tap pipe extension 11 in the plumber's line of sight beneath the base of the sink basin 3 and thus the operation is made easier and quicker.

The provision of clamping face 16 limits the amount by which the tap pipe extension 11 can be screwed onto the tap inlet 5 and thus prevents over-tightening of the connection and possible destruction of the threads on the tap pipe extension 11 or the tap inlet 5. As the clamping face 16 engages with the lip 4 of the sink unit 2, the top of the threads 17 simultaneously engage with the top of the tap inlet 5.

The above described tap pipe extension 11 is for use with a single cold or hot water tap having either a single cold water inlet or a single hot water inlet. However, the tap pipe extension 11 can be modified for use with a mixer tap 1′ having both a hot and a cold water inlet. The hot and cold water inlets of a mixer tap 1′ do not extend beneath the bottom of the tap but are formed in the body of the mixer tap 1′ itself. The inlets are each of circular cross section and are internally threaded. The mixer tap, in use, is located above an aperture or apertures formed in the lip 4 of the sink unit 2.

Referring now to FIG. 4a) a modified tap pipe extension 21 for use with a mixer tap has an annular shoulder 20 instead of the outwardly flared region 15 of tap pipe extension 11. The annular shoulder 20 defines the annular clamping face 16. In this embodiment the threaded region 17 of the pipe 12 extends above the annular clamping face 16 by a predetermined distance. A sealing ‘O’ ring 17′ is located in a circumferential groove adjacent the threaded region 17 of the pipe 12.

In FIG. 4b) a further modified tap pipe extension 31 has the shoulder 20 omitted.

Referring to FIG. 5. a clamping plate 22 is shown for use with the modified tap pipe extensions 21, 31 and a mixer tap 1′. The clamping plate 22 comprises a circular disc having a central axis 23. A circular aperture 24 is located at one side of the axis 23 and an arcuate aperture 25 extending about axis 23 is located on the other side of the axis from circular aperture 24. The arcuate aperture 25 has rounded ends 25′ of radius similar to the radius of circular aperture 24. The first end 13 of the modified tap pipe extension 21 shown in FIG. 4a) extends through the circular aperture 24. The first end 13 of the further modified tap pipe extension 31 shown in FIG. 4b) extends through the arcuate aperture 25.

In use, the mixer tap 1′ is placed on top of the lip 4 of the sink unit 2 above the aperture or apertures (not shown) formed in the lip 4. The upper end 13 of the modified tap pipe extension 21 is inserted through the circular aperture 24 of clamping plate 22 so that the underside of the clamping plate 22 abuts the clamping face 16 of shoulder 20.

The plumber then holds the modified tap pipe extension 21 by the second end 14 and places the first end 13 through an aperture in the lip 4 and into an inlet in the body of the mixer tap 1′. The modified tap pipe extension 21 is rotated by the second end 14 so that the threaded region 17 engages with the threaded region on the cold or hot water tap inlet in the body of the mixer tap 1′. The modified tap pipe extension 21 is turned by applying pressure to the non-round formation 19 until the clamping face 16 of shoulder 20 engages with the underside of the clamping plate 22. This forces the clamping plate 22 into contact with the under-side of the lip 4 to clamp the mixer tap 1′ to the lip 4. The sealing ‘O’ ring 17′ forms a watertight seal between the pipe 12 and the mixer tap inlet.

The arcuate slot 25 of the clamping plate 22 is aligned with and beneath the other water inlet in the body of the mixer tap 1′. The further modified tap pipe extension 31 (of FIG. 4b)) is held by the plumber at second end 14 and the first end 13 is inserted through the slot 25 and screwed into the other water inlet in the mixer tap 1′.

The modified tap pipe extensions 21 and 31 are securely tightened using a spanner or other tightening tool which engages with the non-round formation 19. PTFE tape is then applied to the threaded region of the second end 14 of each tap pipe extension which is then secured to the hot or cold water supply pipe as has been previously described.

It will be appreciated that the tap pipe extensions 21 and 31 used with the mixer tap 1′ are of different lengths but both extend substantially beneath the base of the sink basin 3. The different lengths allow one tap pipe extension 21, 31 to be connected to a substantially horizontal hot or cold water supply pipe (not shown) and the other tap pipe extension 21, 31 to be connected to another substantially horizontal water supply pipe (not shown) such that the hot and cold water supply pipes are substantially parallel to one another. The water supply pipes can alternatively be inclined to the horizontal or the supply pipes can be substantially vertical.

The arcuate aperture 25 of the clamping plate 22 allows some relative movement between the clamping plate 22, the modified tap pipe extension 31 and an inlet of the mixer tap when the other tap pipe extension 21 has been inserted through the circular aperture 24. This relative movement aids assembly of the components. However, the arcuate aperture 25 could alternatively be in the form of a circular aperture.

FIGS. 7 and 8 show a relatively short tap pipe extension 41 suitable for use with a wash basin tap. The extension 41 is formed of moulded plastics and comprises a stepped bore 42, an intermediate bore portion being provided with threads 17 for threaded engagement by the threads on the lower part of a tap inlet, such as the tap inlet 5 of the tap of FIG. 1. The extension 41 is of uniform hexagonal horizontal section for substantially the full height of the extension 41 to enable a spanner easily to be engaged with the side wall 43 of the extension. Although the body is relatively shorter, the spanner can still be engaged at a position of the body remote from the upper end of the body.

FIGS. 9 and 10 show an extension similar to that of FIGS. 7 and 8 but dimensioned to fit a bath tap.

FIGS. 11 and 12 show further embodiments in which the tap pipe extension incorporates a flexible hose 44. The hose 44 can be a length of flexible hose material of suitable plastics/rubber material which is preferably sheathed with a braided wire cover 45 to provide resistance against abrasion during installation and use. In FIG. 11 the extension comprises a moulded plastics extension body 41′ of similar shape to the extension 41 of FIGS. 7 and 8, but without the threaded lower end 18. Instead, the upper end of the flexible hose 44 is moulded into the body 41′ so as to communicate freely with lower end of the bore of the body.

The lower end 50 of the flexible hose 44 is secured by a swaged collar 47 to a tubular fitting 46, the fitting 46 carrying an integral nut 48 and an internally threaded nut 49, to enable the lower end 50 to be connected to a water supply pipe.

The advantage of the extension of FIG. 11 is that the extension can be readily assembled to a tap inlet, by manipulation of the lower end of the flexible hose 44, initial engagement with the tap inlet threads being achieved by finger-turning of the nut 48. Once the extension has been finger-tightened, a spanner can be applied directly to the flats of the extension body 41′.

The extension 61 of FIG. 12 is similar to that of FIG. 11 except that the extension body is of the form shown in FIG. 2 but omitting the threaded lower end 18.

1. A tap pipe extension comprising a first end provided with first securing means to releasably secure the first end to a tap inlet, a second end provided with second securing means to releasably secure the second end to a fluid supply pipe, and a nonround formation at a position remote from the first end, the pipe extension being of a length greater than the length of the tap inlet, the arrangement being such that, in use, the non-round formation is operable to secure the first securing means of the tap pipe extension to the tap inlet.

2. The tap pipe extension of claim 1 wherein the first securing means comprise screw threads to engage with screw threads on the tap inlet.

3. The tap pipe extension of claim 2 wherein the first securing means comprises a stepped bore and an intermediate bore portion being provided with threads for the threaded engagement by the threads on the lower part of the tap inlet.

4. The tap pipe extension of claim 1 wherein the second securing means comprises screw threads to enable a connection to be made to the fluid supply pipe.

5. The tap pipe extension of claim 3 comprising a rigid tubular body formed at opposite ends thereof with said screw threads of the first and second securing means.

6. The tap pipe extension of claim 1 comprising a rigid tubular body to the lower end of which is secured a flexible hose, and the free end of the flexible hose is provided with said second securing means.

7. The tap pipe extension of claim 1 wherein the first securing means further comprises an annular clamping face which is substantially perpendicular to a longitudinal axis of the tap pipe extension such that, in use, part of a sink unit or bath is clamped between the tap and the clamping face, the non-round formation being operable to secure the first securing means to the tap inlet.

8. The tap pipe extension of claim 1 wherein the non-round formation comprises at least one pair of opposed, parallel faces.

9. The tap pipe extension of claim 1 wherein the non-round formation comprises a hexagonal formation having three pairs of opposed, parallel faces.

10. The tap pipe extension of claim 1 wherein the tap pipe extension, in use, connects a hot or cold water tap inlet of a hot or cold water tap to hot or cold water supply pipe-work.

11. The tap pipe extension of claim 1 wherein, in use, a first tap pipe extension connects a cold water inlet of a hot and cold water mixer tap to a cold water supply and a second tap pipe extension connects the hot water inlet and a hot water supply.

12. The tap pipe extension of claim 10 wherein the first tap pipe extension and the second tap pipe extension are of different lengths.

13. The tap pipe extension of claim 10 as dependant on claim 6 wherein only the securing means of the first tap pipe extension comprises a clamping face.

14. The tap pipe extension of claim 12 wherein the clamping face is defined by a peripheral annular shoulder.

15. The tap pipe extension of claim 10 further comprising a clamping plate having at least two apertures through which, in use, respective tap pipe extensions are received.

16. The tap pipe extension of claim 14 wherein one of the apertures is substantially circular and the second aperture is substantially arcuate, the circular aperture receiving the tap pipe extension having the clamping face.

17. The tap pipe extension of claim 14 wherein the clamping plate is substantially circular.

18. The tap pipe extension of claim 14 wherein the first securing means further comprises an annular clamping face which is substantially perpendicular to a longitudinal axis of the tap pipe extension such that, in use, part of a sink unit or bath is clamped between the tap and the clamping face the non-round formation being operable to secure the first securing means to the tap inlet and wherein the clamping plate is brought into clamping engagement with part of a sink unit by the clamping face on the first tap pipe extension.

19. A tap assembly comprising a tap having a tap inlet, a sink unit or bath, a tap pipe extension, and fluid supply pipe-work, the first end of the tap pipe extension being secured to the tap inlet such that part of the sink unit or bath is clamped between the tap and the tap pipe extension, the second end of the tap pipe extension being secured to the fluid supply pipe-work.

20. The tap pipe extension of claim 18 wherein the tap inlet or the first end of the tap pipe extension passes through an aperture in the sink unit or bath.
